(19) United States
(12) Patent Application Publication
(10) Pub. No.: US 2026/0078666 A1
(43) Pub. Date: Mar. 19, 2026

(54) STREAMING POTENTIAL MEASUREMENTS BY MODULATING PUMP FLOW RATE OR PRESSURE

(71) Applicant: ESG SOLUTIONS GROUP, INC., Houston, TX (US)

(72) Inventors: Jeffrey Chen, Houston, TX (US); Trevor Keith Charles Pugh, Tomball, TX (US)

(21) Appl. No.: 19/394,773

(22) Filed: Nov. 19, 2025

Related U.S. Application Data
(63) Continuation-in-part of application No. 19/211,718, filed on May 19, 2025.
(60) Provisional application No. 63/649,556, filed on May 20, 2024.

(51) Int. Cl. E21B 47/002; E21B 43/12; F04B 43/02; F04B 43/12; G01V 3/12

(52) U.S. Cl. CPC E21B 47/0025; E21B 43/12; G01V 3/12; F04B 43/02; F04B 43/12

(57) ABSTRACT

An assembly and method are disclosed for generating and detecting a modulated pressure signature in a fluid transported to a subsurface injection zone. The assembly includes a pump, a pulsation dampener, and a pressure modulation device that oscillates pressure to produce a frequency-modulated signature in the fluid, resulting in an alternating current streaming potential (AC-SP) at the injection zone. The method includes recording modulated electromagnetic signals at an array of electromagnetic field receivers on a surface above the subsurface injection zone, processing the data to identify source frequency signals, and correlating these signals to image subsurface fluid or pressure distribution, enabling three-dimensional mapping of subsurface structures.

### CROSS-REFERENCE TO RELATED APPLICATION(S)

This patent application is a continuation-in-part application of U.S. application Ser. No. 19/211,718, titled “STREAMING POTENTIAL MEASUREMENTS BY MODULATING PUMP FLOW RATE OR PRESSURE,” filed on May 19, 2025, which, in turn, claims the benefit of priority from U.S. Provisional Application No. 63/649,556, filed on May 20, 2024, and incorporated by reference herein in its entirety for all intents and purposes.

### BACKGROUND

### 1. Field of Disclosure

Embodiments of the present disclosure relate to the field of geophysics, and, in particular, to equipment and techniques for inducing a modified Streaming Potential (SP) in a geologic formation.

### 2. Related Art

Within the field of geophysics, various investigations of the use of SP for geologic formation analysis have been performed. See, e.g.:
De Groot, S., 1951, Thermodynamics of irreversible processes, in J. de Boer, H., and H. B. G. Casimir, Eds., Selected Topics in Modern Physics, Vol. 3: North Holland Publishing Company, Amsterdam.
Corwin, R. F., 1990, The self-potential method for environmental and engineering applications, in Ward, S. H., Ed., Geotechnical and environmental geophysics, 01: Soc. Expl. Geophys., 127-145.
Ishido, T., and Pritchett, J. W., 1999, Numerical simulation of electrokinetic potentials associated with subsurface fluid flow: J. Geophys. Res., 104(B7), 15,247-15,259.
Moore, J. R., and S. D. Glaser (2007), Self-potential observations during hydraulic fracturing, J. Geophys. Res., 112, B02204, doi: 10.1029/2006JB004373.
Revil, A., Schwaeger, H., Cathles I I I, L. M., and Manhardt, P. D., 1999, Streaming potential in porous media 2: Theory and application to geothermal systems: J. Geophys.Res., 104(B9),20,033-20,048.
Wurmstich, B., and Morgan, F. D., 1994, Modeling of streaming potential responses caused by oil well pumping: Geophysics, 59, 46-56.
Ahmed, Tarek H., 2010, Reservoir Engineering Handbook. 4th Edition. Gulf Professional Publishing.
Minsley, B. J., 2007, Modeling and Inversion of Self-Potential Data, Ph.D thesis, Massachusetts Institute of Technology.
Constable, C. and Constable, S., 2023, A grand spectrum of the geomagnetic field, Physics of the Earth and Planetary Interiors, 344, 2023.
Reppert, P. M., Morgan, F. D., Lesmes, D. P., and Jouniauxz, L., 2001, Frequency-Dependent Streaming Potentials: Journal of Colloid and Interface Science 234, 194-203; doi: 10.1006/jcis.2000.7294, available online at http://www.idealibrary.com.
Pugh, T. K. C., and Chen, J., 2023, System and method for combined streaming potential and controlled-source EM modeling; US patent application Pub No: US2024/0085584.
Dusterhoft, Ronald et al of Haliburton, 2019 Electric pump flow rate modulation for fracture monitoring and control. U.S. Pat. No. 11,143,005.
George, Paul et al 2020, Control, integration, and modulation systems and methods for regulating hydraulic fracturing systems when combined with a pressure exchange system. U.S. Pat. No. 11,598,189.

### SUMMARY

In an embodiment, an assembly for generating a modulated pressure signature in a fluid being transported to an injection zone includes a pump configured to deliver fluid to a fluid output manifold. The assembly further includes a pulsation dampener fluidly connected to the manifold, the pulsation dampener having a barrier separating a first side from a second side, the first side comprising the fluid, and the second side comprising at least one of a gas, a liquid, or a non-compressible fluid. The assembly also includes a pressure modulation device coupled to the second side and configured to oscillate pressure of the second side at a modulation frequency, such that the output from the pump and the modulation frequency are combined to produce a modulation signature in the fluid, the modulation signature being characterized by a frequency spectrum. In the assembly, the modulation signature is coupled to the fluid being transported to the injection zone, thereby generating an alternating current streaming potential (AC-SP) at the injection zone.

In another embodiment, a method for detecting and imaging subsurface fluid distribution in an injection zone includes positioning an electromagnetic field receiver array comprising a plurality of receivers at a plurality of locations on a surface above the injection zone and configuring the electromagnetic field receiver array to record electromagnetic field data. The method further includes operating a pressure oscillation device to generate pressure oscillations at a selected source frequency and receiving time domain electromagnetic field data at each receiver of the plurality of receivers during operation of the pressure oscillation device. The method also includes processing the time domain electromagnetic field data to obtain frequency domain data using a Fast Fourier Transform. Furthermore, the method includes identifying source signals at the selected source frequency in the frequency domain data at each receiver of the plurality of receivers and correlating the identified source signals across the electromagnetic field receiver array to generate correlated data representative of subsurface fluid or pressure distribution. The method further includes generating a three-dimensional image of the pressure field or fluid saturation in the subsurface structure by performing an inversion on the correlated data.

### BRIEF DESCRIPTION OF DRAWINGS

The present technology will be better understood by reading the following detailed description of non-limiting embodiments thereof and by examining the accompanying drawings, in which:

FIG. 1 illustrates a graph of the exemplary power spectrum of an ambient natural magnetic field, in accordance with embodiments of the present disclosure;

FIG. 2 illustrates an example of the real, and imaginary parts of the SP cross-coupling coefficients obtained in laboratory tests and indicative of the determination that the SP signal is frequency-dependent and can be modulated by the applied pressure in the lab setting, in accordance with embodiments of the present disclosure;

FIG. 3 depicts an example of a three-dimensional resistivity model including layout of both transmitter and receivers and their relationship to the casing in accordance with Controlled Source ElectroMagnetics (CSEM) modeling, in accordance with embodiments of the present disclosure;

FIG. 4A illustrates an example of a waveform combined with pump noise showing the modulation of the injection rate or pressure, in accordance with embodiments of the present disclosure;

FIG. 4B illustrates the frequency domain plot of the modulated injection rate in FIG. 4A, in accordance with embodiments of the present disclosure;

FIG. 5 shows an example of how to impose an oscillatory pressure signature on the high-pressure output of a large high-pressure pump, in accordance with embodiments of the present disclosure; and

FIG. 6 is a flowchart showing an example of how a system may be set up to impose an oscillatory pressure signature on a high-pressure output of a large high-pressure pump, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/−10 percent. Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures, and the similar features may be identified with like reference numerals for convenience purposes only and not to limit the scope of the present disclosure.

Conventional CSEM relies upon transmitting sources created by using generators coupled with a signal switching system to produce an Alternating Current (AC) Electromagnetic (EM) field. In such a configuration, a surface-based array of electric field sensors is used along with a surface array of receivers and transmitters to facilitate generation of a broadband, flat, stable, low-frequency signal having the same frequency content as a near-infinite impulse. To create a 2D image of a fluid injection, the total electric field measured at the start of a fluid injection operation is subtracted in the frequency domain from the readings as injection proceeds. This produces a scattered field response in both amplitude and phase, which is directly correlated to subsurface fluid activity.

Conventional CSEM models scattered field responses using well-understood forward modeling methods based on solving Maxwell's equations (quasi-static). Disclosed embodiments are at least partially based on the inventors' recognition that fluid injection modifies the physical mechanisms which are not adequately described in those equations. As a result, disclosed embodiments can be treated as additional “transmitting” sources to generate EM fields in order to implement an active CSEM system with reduced implementation complexity and cost.

More specifically, the presently disclosed embodiments provide an alternate transmitting source that produces a low frequency AC electromagnetic field using a surface, or in borehole, pressure and flow oscillator, which in turn causes a SP effect to move from a quasi-Direct Current SP (quasi-DC-SP) voltage to a low frequency Alternating Current-Streaming Potential (AC-SP) voltage, resulting in a modified streaming potential, e.g., an AC-SP signal.

The AC-SP source has the advantage of being at the location of the fluid injection subsurface, unlike a conventional CSEM source which is on the surface and requires additional power to create both the primary and secondary fields. Thus, the presently disclosed embodiments provide a new active streaming potential method based on measurement of the SP signal in the frequency domain (AC-SP).

It should be appreciated that, in accordance with the disclosed embodiments, methodologies may also modulate the injection pump rate and/or pressure in a vertical shaft used, for example, in an injection well, a borehole or any other sub-surface vertical shaft requiring monitoring or analysis. Boreholes and injection wells both involve creating shafts in the ground, but their primary purposes differ. Boreholes are primarily used for extracting fluids or gases from the ground, while injection wells are designed to inject fluids underground. The presently disclosed embodiments have technical utility for either implementation by improving the ability to significantly reduce the noise floor for the SP signal, making it possible to take advantage of the SP signal in a variety of potential applications.

Preliminarily, it should be understood that there is a distinction to be made between “passive” electromagnetic measurements, that are performed in the absence of an electromagnetic source where the surface recorders measure only the background electromagnetic field as opposed to an “active” measurement that can include electromagnetic sources created by technologies other than an electrical generator used to power an electronic transmitting source.

Conventional SP technology provides a passive geophysical tool which measures naturally occurring electric fields or voltages created by fluid flow through geologic formations. Widely recognized applications of passive SP techniques range from monitoring dam leakage, estimating the hydraulic conductivity in hydrogeology, monitoring volcano and geothermal activities, and well logging in the oil and gas industry. Conventional passive SP methodologies provide ease of data acquisition, without requiring an actively man-made excitation source to generate such data for analysis.

However, conventional passive SP has limitations in that the approach only captures data after an issue has occurred, making it a reactive approach to identifying and addressing problems. Thus, proactively mapping an environment as part of design and exploration is quite limited, particularly when the environment is being altered as in hydraulic fracturing in the petroleum industry and rock removal in the mining industry. Additionally, passive SP can generate large amounts of log data that do not enable efficient and compact analysis and interpretation.

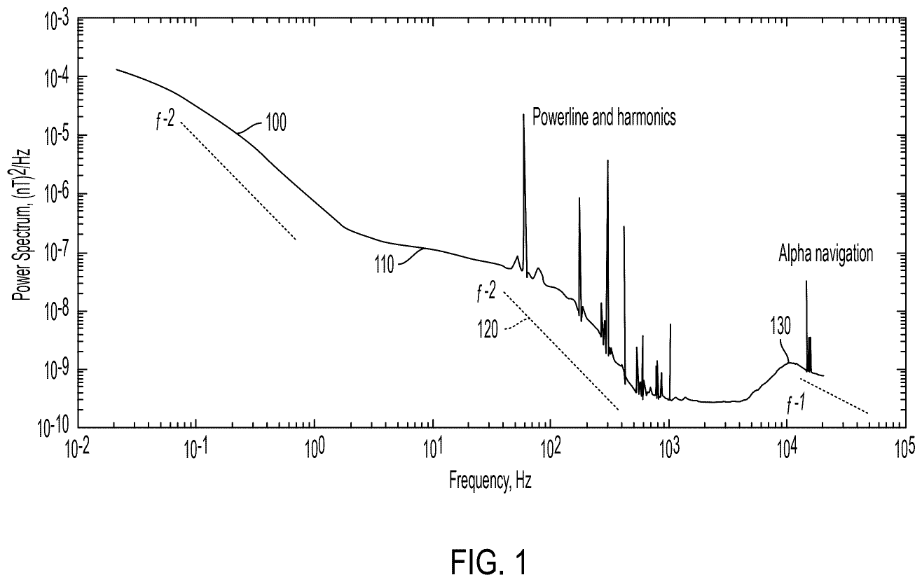

With these limitations of conventional approaches in mind, disclosed embodiments combine SP response analysis with an active CSEM source on the surface that enables detection of both SP and EM responses. In accordance with the presently disclosed embodiments, a new AC-SP source is used that does not require an electrical generator with an associate transmitter and is located at the injection zone within the vertical shaft rather than at an entrance to the shaft at the surface. Referring now to FIG. 1, that figure illustrates a graph of an exemplary power spectrum of an ambient natural magnetic field. The low frequency range of interest for this embodiment is indicated as 110. As shown in FIG. 1, frequency-dependent AC-SP measurement has particular technical utility in that it may be used to reduce the SP noise floor present in the conventional measurement spectrum 100 and improve by several orders of magnitude, as indicated by the desired spectrum at 110. Use of frequency-dependent SP measurement enables detection of much smaller pure AC-SP signals. Accordingly, frequency-dependent AC-SP measurement may be used to extend applications to previously unattainable applications including but not limited to monitoring Carbon Capture, Utilization and Storage (CCUS) injection and leakage, monitoring CCUS plume extent, monitoring hydraulic fracking, geothermal monitoring and Enhanced Oil Recovery (EOR) performed by water or CO₂. Additionally, technical utility of the disclosed embodiments has significant applications in hydrologic well testing, wastewater injection monitoring and monitoring of wastewater wells for plume extent.

Ongoing research and development is underway to determine how AC-SP data can be used to monitor and characterize fluid/CO₂ injection-related activities in reservoir formations. Conventionally, passive quasi-DC SP methodologies have been used to measure naturally occurring electric fields or voltages created by fluid flow through geologic formations in order to characterize their composition and extent. Passive quasi-DC-SP monitoring is based on the well-known electrokinetic phenomenon described as follows.

According to the coupled flow theory of irreversible thermodynamics, different flows are interrelated and affect each other as discussed in De Groot, S., 1951, THERMODYNAMICS OF IRREVERSIBLE PROCESSES, in J. de Boer, H., and H. B. G. Casimir, Eds., Selected Topics in Modern Physics, Vol. 3: North Holland Publishing Company, Amsterdam. Thus, the relationship between hydraulic flow and electrical flow can be expressed as:

$$q = - \frac{k}{μ} * ∇ P - {k}_{e} * ∇ φ \qquad ( 1 )$$

$$J = - {L}_{∇ p} * ∇ P - σ * ∇ φ \qquad ( 2 )$$

$$where : \\ q : volumetric fluid flux vector [ {m}^{3} / ( s \cdot {m}^{2} ) ] \\ J : current density vector [ A / {m}^{2} ] \\ P : Pore pressure of the fluid [ Pa ] , \\ φ : electrical potential [ V or mV ] \\ σ : conductivity [ S / m ] \\ {k}_{e} : coefficient of electro - osmoic permeability [ {m}^{2} / ( s \cdot V ) ] \\ {L}_{∇ p} : streaming current cross - coupling coefficient [ A \cdot {s}^{2} / kg ] \\ k : intrinsic permeability [ {m}^{2} ] \\ μ : dynamic viscosity [ Pa \cdot s = kg / m \cdot s = 1 Poise ]$$

In addition, the reciprocal nature of the coupled flow equations enables

$${L}_{V p} = {k}_{e} \qquad ( 3 )$$

In the absence of external current sources, the hydraulic flow equation may be decoupled and analyzed directly using Darcy's law in materials in which hydraulic conductivity K>10−9 m/s. This has particular technical utility in application to hydraulic fracking or CO₂ injection in which large hydraulic gradients exist.

More specifically, under steady-state flow conditions, q satisfies Darcy's law:

$$∇ \cdot q = - ∇ \cdot ( K * ∇ p ) = Q \qquad ( 4 )$$

where Q is the volumetric rate per unit volume [l/s], and K is the hydraulic conductivity [m/s].

Further, when there is no external electric source, it should be understood that Eq. (2) obeys Ohm's law. Thus,

$$∇ \cdot J = - ∇ \cdot ( {L}_{∇ p} * ∇ p ) - ∇ \cdot ( σ * ∇ φ ) = 0 \qquad ( 5 )$$

Considered differently, this is the basis for solving for streaming potential φ by:

$$∇ \cdot ( σ * ∇ φ ) = - ∇ \cdot ( {L}_{∇ p} * ∇ p ) \qquad ( 6 )$$

Once the pressure field has been obtained from Eq. (4), the right-hand side in Eq. (6) may serve as a source term for the SP forward modeling problem as generally understood in the art discussed in the background section of the present application.

With this understanding of the theoretical constructs for modeling SP in mind, it is understood that a real-world implementation of the concepts is more challenging to analyze. When CO₂ or water is injected into the target zone, there is a transient flow problem in that fluid flows with changes in velocity and pressure over time, e.g., during pump startup/shutdown, valve operations etc. This can be addressed by solving the multi-phase, compositional equations in the reservoir simulation domain.

Reservoir simulation is performed to predict the behavior of underground reservoirs using software to improve field development, resource management, and optimize production. As discussed in Ahmed, Tarek H., 2010, RESERVOIR ENGINEERING HANDBOOK. 4th Edition. Gulf Professional Publishing, reservoir simulation is described in the following compositional governing equations:

$$∇ \cdot [ K {\sum }_{j = o , w , g} {f}_{i j} \frac{{ρ}_{j} {K}_{r j}}{{μ}_{j}} ( ∇ {p}_{j} + {γ}_{j} ∇ Z ) ] + {Q}_{i} = \frac{\partial }{\partial t} [ ϕ {\sum }_{j = o , w , g} {f}_{i j} {ρ}_{j} {S}_{j} ] \qquad ( 7 )$$

where the component i=1, 2, . . . , Nc, Nc is the number of compositional units, K denotes the absolute permeability tensor, j=o, w, g, representing the oil, water, and gas phases, fᵢⱼ is the fraction factor of phase j in unit i, ρⱼ, Kᵣⱼ, and μⱼ denote the phase density, relative permeability, and viscosity, respectively, γⱼ is the phase gravity, and Z is the vertical depth; Qᵢ is the source term for injection or flowback of fluid.

On the right-hand side of Eq. (7), φ is the porosity and S represents the phase saturation.

Together with related auxiliary equations for saturations, relative permeability, capillary pressure, PVT properties, and rock properties, both the pressure field ρⱼ and Sⱼ are simultaneously solved using a variety of numerical algorithms, such as Finite Element (FE) or Finite Difference (FD) based methods. Conventionally known FE computational methods predict how a structure behaves in real-world conditions by dividing the structure into smaller components which can be modelled using mathematical equations specific to each component. Conventionally known FD-based methods leverage finite differences or difference quotients to approximate derivatives as part of the numerical analysis of differential equations.

By combining Eq. (6) and (7), it can be understood that the SP signal can be attributed to two variables: fluid injection rate Q and pore pressure gradient. Conceptually, the fluid injection rate can be treated as a point source while the pore pressure gradient can be thought of as a volumetric current source as discussed in Minsley, B. J., 2007, MODELING AND INVERSION OF SELF-POTENTIAL DATA, Ph.D thesis, Massachusetts Institute of Technology.

With this general understanding of the relationship between a quasi-DC-SP signal and fluid injection rate Q and pore pressure gradient in mind, it should be noted that according to the electrokinetic theory discussed above, an SP signal is a DC or very low-frequency EM field. Thus, ambient EM fields throughout the power spectrum may have significant effect.

Referring again to FIG. 1, the estimated noise floor conventionally known techniques for quasi-DC-SP measurements is about 0.1 mV 100 (see background section of the present application), which is several orders of magnitude higher than the noise floor commonly used in conventional CSEM signals 110. By causing pressure and flow to change sinusoidally the SP response can be moved to a higher AC frequency 110, avoiding l/f noise present in instrumentation, and ambient electromagnetic field noise. This is consistent with the observed natural magnetic field spectrum 100-130, without an active man-made source.

FIG. 1 graphs the power spectrum of an ambient natural magnetic field. A corresponding power spectrum of an electric field would be expected to have similar characteristics. It is these ambient fields that are the source of the major noise for a quasi-DC-SP signal.

In the frequency range of approximately 0.01 Hz-1 Hz (reference numeral 100), the power spectrum of the magnetic field decreases proportionally to f², with a magnitude from approximately 10⁻⁴ nT²/Hz down to approximately 10⁻⁷ nT²/Hz. In the range of approximately 1 Hz-50 Hz (reference numeral 110), the power spectrum slightly decreases at the level of approximately 10⁻⁷ nT²/Hz. The difference is almost three orders of magnitude between these two frequency sub-ranges 100 and 110. In the frequency range of approximately 50 Hz-500 Hz (reference numeral 120), the power spectrum of the magnetic field decreases proportionally to f², with a magnitude from approximately 10⁻⁷ nT²/Hz down to approximately 10⁻⁹ nT²/Hz.

The improvement in background noise of ambient fields between 100 and 110 on SP signals leads to the technical utility and substantial benefit of being able to measure SP signal in the frequency domain (1 Hz-50 Hz) 110, as compared to the conventionally available quasi-DC-SP measurement frequency range 100. Thus, using the AC-SP measurement, in accordance with the disclosed embodiments, significantly reduces the noise floor for the SP signal, making it possible to take advantage of the SP signal in a variety of potential applications, such as in CO₂ plume monitoring, hydraulic fracking, formation characterizations, hydrological testing, and geothermal assessment.

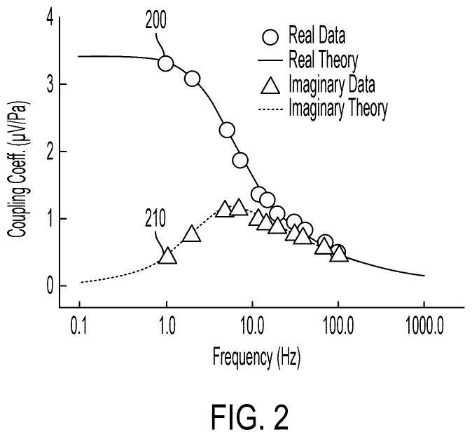

Various conventional investigations have been carried out to analyze frequency-dependent AC-SP signals in lab tests. Experimental apparatus and data acquisition have been performed to measure the SP coupling coefficients as a function of frequency. See Reppert, P. M., Morgan, F. D., Lesmes, D. P., and Jouniauxz, L., 2001, FREQUENCY-DEPENDENT STREAMING POTENTIALS, Journal of Colloid and Interface Science 234, 194-203; doi: 10.1006/jcis.2000.7294Z. Referring now to FIG. 2, investigations included measurement of the real 200 and imaginary 210 portion of streaming potentials, and frequency-dependent AC-SP laboratory experiments conducted on one glass capillary and two porous glass samples, wherein the real 200, and imaginary 210 parts of the SP cross-coupling coefficients are indicative of the determination that the SP signal is frequency-dependent and can be modulated by the applied pressure in the lab setting.

Disclosed embodiments take advantage of the frequency-dependent AC-SP measurements by providing a Streaming Potential Controlled Source ElectroMagnetics (spCSEM) method, which combines SP and CSEM together. See Pugh, T. K. C., and Chen, J., SYSTEM AND METHOD FOR COMBINED STREAMING POTENTIAL AND CONTROLLED-SOURCE EM MODELING, US patent application Pub No: US 2024/0085584. In this method, an external electric source is excited to modulate the SP signal at the same frequency as applied. Based upon an improved understanding of the mechanism of SP under an external EM exciting source, a new spCSEM modeling algorithm may be considered as an additional source for generating the spCSEM's electromagnetic signal.

More specifically, besides the previously identified excitation current J^{e}, under the present approach, the streaming potential current J^{sp} can be treated as an additional source for generating the spCSEM's electromagnetic signal. The streaming current J^{sp} can be obtained by the following equation:

$${J}^{s p} = - {L}_{∇ p} * ∇ p \qquad ( 8 )$$

where L_{∇p} is the cross-coupling coefficient between a fluid and electric flow in the coupled flow theory discussed above, and p is the pressure field, which may be solved in a reservoir simulation or geo-mechanical platform. Therefore, the modified frequency-domain EM equations for spCSEM might look like:

$$∇ \times E + i ω μ H = 0 \qquad ( 9 )$$

$$V \times H - σ E = {J}^{e} + {J}^{s p} \qquad ( 10 )$$

By solving these equations, both electric and magnetic fields can be computed to provide a spCSEM frequency-domain forward modeling engine. However, one limitation to this conventionally known approach is that transmitting equipment needs to be provided, as discussed in US patent application Pub No: US 2024/0085584, causing a significant additional survey cost.

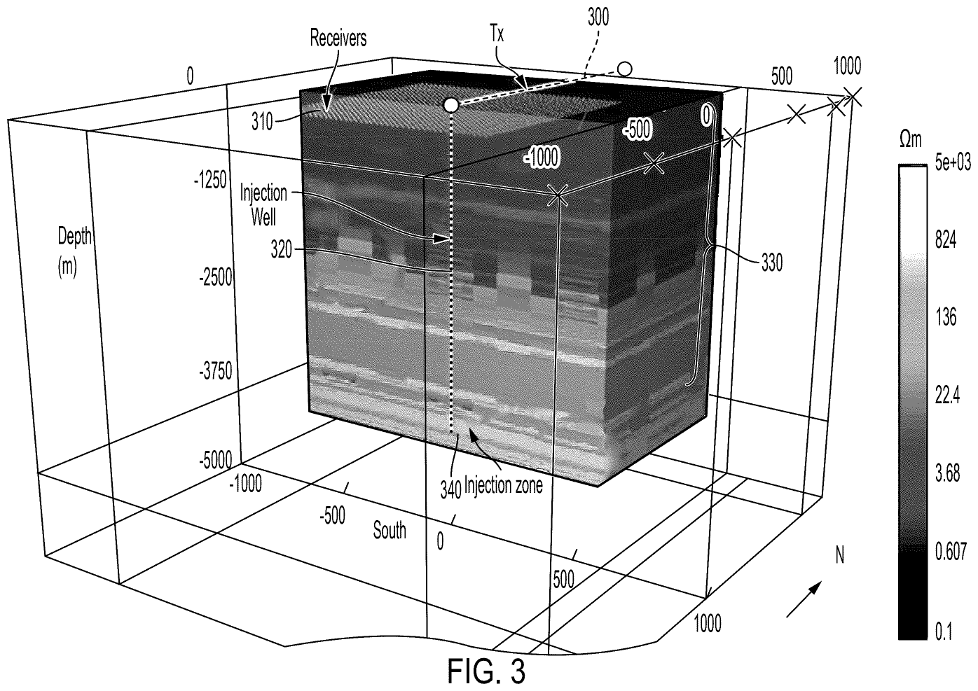

Referring now to FIG. 3, a three-dimensional resistivity model 330 is illustrated, including the layout of both transmitter 300 and receivers 310 on the surface, in a conventional implementation of CSEM as well as in active spCSEM modeling in accordance with the disclosed embodiments. As shown in FIG. 3, the conventional CSEM approach includes the layout of both transmitter 300 and receivers 310 and their relationship to the casing 320. The 3D modeled resistivity 330 and the subsurface injection zone 340 are also illustrated.

In a conventional approach “active” CSEM transmitter is located at the surface and is indirectly coupled to the vertical borehole at 300. To the contrary, in a conventional SP approach that includes “passive” electromagnetic measurements, there would be no electromagnetic source(s) at 300 and the surface recorders 310 would measure only the background electromagnetic field.

In accordance with the disclosed embodiments implementing active spCSEM modelling, electromagnetic sources are created by technologies other than an electrical generator used to power an electronic transmitting source 300. Instead, in accordance with the presently disclosed embodiments, a new AC-SP source at the injection zone 340 and is generated by the modulation of the injection pump rate and/or pressure to provide the functionality of an active SP methodology without the use of an electrical generator.

Accordingly, disclosed embodiments provide a method and system for measuring a streaming potential in a geologic formation, wherein a pump injection rate and/or pressure, causing a predetermined waveform in the pump flow rate or pressure are modulated, and a streaming potential signal responsive to the modulation of the pump injection rate or pressure by an electromagnetic receiver is received and analyzed.

Although technical utility of the disclosed embodiments may be present in both active and passive SP based approaches, the use of the present innovation to provide an active SP or AC-SP method enables monitoring equipment to be used that does not require deployment of transmitter equipment 300, thereby significantly reducing survey costs. Thus, from a technology implementation perspective, at least some presently disclosed embodiments do not require the use of any electronic transmitter or synchronization with pump modulation.

Put another way, disclosed embodiments can provide a passive surface monitoring system 310 using an active subsurface AC-SP provided source at the injection zone 340. The AC-SP source has the advantage of being at the location of the fluid injection zone 340 subsurface, unlike a conventional CSEM source 300 that is on the surface and requires additional power to create both the primary and secondary fields. The AC-SP source at the injection zone 340 only requires enough power to create the secondary field and the surface response will be similar to the conventional CSEM method. Thus, surface equipment may be limited to a plurality of receivers in an array recording the AC-SP signal in a time series on the surface, reducing operational costs and signal uncertainty significantly.

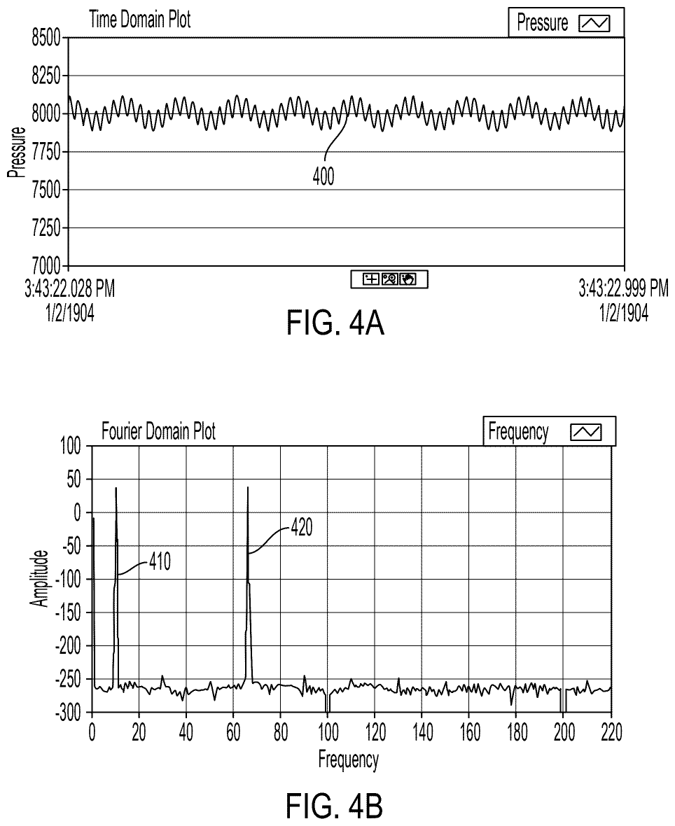

Referring now to FIG. 4A, a modulated pump flow rate and/or pressure may look like the curves 400. FIG. 4A illustrates an example of a waveform combined with pump noise 400 showing the modulation of the injection rate or pressure in accordance with disclosed embodiments. Various feasible waveforms for modulating the injection rate and/or pressure may be utilized including sine, square, sawtooth triangle, Walch functions, chirps, and short chip count Pseudo Random numeric codes. These predetermined waveforms can be modulated on top of the required hydrostatic pressure 405 to prevent affecting subsurface pressure requirements.

Referring now to FIG. 3, the time domain data containing the pump noise and modulated waveform, can optionally be converted into frequency domain data in a plurality of receivers in an array 310 or in a computer system that collects the time domain data from the receiver array 310 and converts it to the frequency domain.

Referring now to FIG. 4B, the Fourier transform or frequency domain response can be used to uniquely separate the designed signal 410 imposed on the high-pressure fluid being injected into the injection zone from the pump noise 420. FIG. 4B illustrates the frequency domain plot of the modulated injection rate 400 in FIG. 4A. As shown in FIG. 4B, the modulated injection rate signal 410 can be distinguished from the pump noise 420.

In accordance with at least some disclosed embodiments, at least one electromagnetic receiver is one of an array of electromagnetic receivers receiving an SP signal responsive to the modulation. In such an implementation, the pump modulation signal data acquisition may be synchronized relative to the signal data acquisition of the array of electromagnetic receivers to further reduce noise. In this way, data acquisition is synchronized among the receivers such that the pressure measurement and voltage measurement performed by the receivers are synchronized.

Optionally, synchronization between pump modulation and the array of receivers may further reduce noise. In such an implementation a Fast Fourier Transform (FFT) may be used to convert the time-domain AC-SP data to the frequency-domain 430. Subsequently, a frequency-domain AC-SP data inversion may be used to monitor how water and/or a CO₂ front is moving with time.

Further, once synchronization is achieved the receiver signal may be divided by the pump pressure signal in the Fourier or Frequency domain in order to compensate for pump pressure fluctuations.

In accordance with various disclosed embodiments, there are several alternative ways to modulate pump flow rate and/or pressure. For example, one such approach to creating modulations and fluctuations is disclosed in Glen, Ronald et al. of Haliburton, 2019 ELECTRIC PUMP FLOW RATE MODULATION FOR FRACTURE MONITORING AND CONTROL. The flow rate of a pump can be controlled in various different manners including throttling (in which, a valve in the discharge line is closed to throttle the discharge), controlled bypassing (in which liquid is allowed to bypass from the pump discharge back to the suction vessel), varying pump speed (to change the pump's speed as discussed in detail in Glen, Ronald et al.), implementation of a recirculation loop (by setting up a bypass line with a pressure bypass valve to ensure the pump meets its minimum flow requirements), implementation of a feedback-based control loop such as a Proportional-Integral-Derivative (PID) loop to electronically control the loop based on the output from a flow meter; adjustment of a pump outlet valve (to change the opening of the pump outlet valve while the pump speed remains unchanged); utilization of flow control valves (to control the volumetric rate of the fluid that flows through them by changing the size of the orifice), use of a tapered needle (to move the needle in and out of an orifice or opening and close the gap inside a ball valve to change the rate), and/or performing transfer injection to other wells in a system causing a geometric shift in the pressure field.

Additionally, the flow rate of a pump can be controlled using a system of pressure accumulators connected to the high-pressure side of the pumping system, where the nitrogen pressure charge in the accumulators is modulated causing the accumulators to modulate the pressure into the wellbore. For example, the required modulation for at least some disclosed embodiments may be provided by modifications to the device and method and device disclosed in George, Paul et al 2020, CONTROL, INTEGRATION, AND MODULATION SYSTEMS AND METHODS FOR REGULATING HYDRAULIC FRACTURING SYSTEMS WHEN COMBINED WITH A PRESSURE EXCHANGE SYSTEM.

Alternatively, or in addition, Adjustable Speed Drive (ASD) pumps may be used when pumps are required to operate at least 2,000 hours per year and process flow rate requirements vary by 30% or more over time.

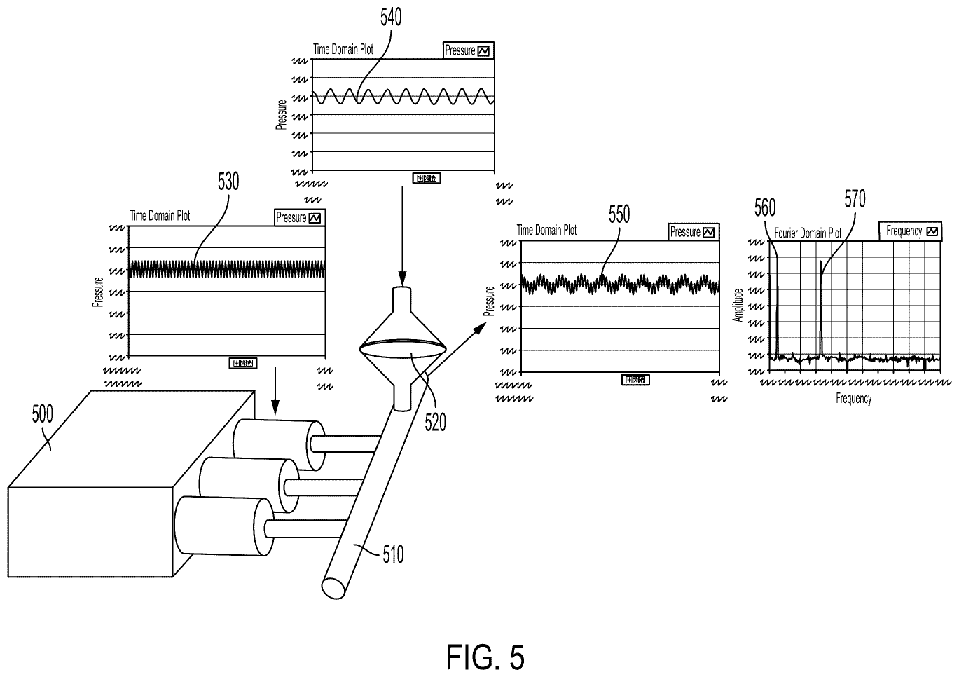

Referring now to FIG. 5, the diagram shows an example of how a triplex pump 500 can be connected through a fluid output manifold 510 to a driven pulsation dampener 520. In this embodiment, the triplex pump 500 may be any high-pressure, positive displacement pump suitable for industrial fluid injection, such as water, CO₂, or other treatment fluids. The fluid output manifold 510 may be constructed from high-strength steel or composite materials and may include one or more pressure sensors, flow meters, or temperature sensors to monitor the characteristics of the fluid being delivered.

FIG. 5 illustrates an example of how to impose an oscillatory pressure signature on the high-pressure output of a large high-pressure pump. More specifically, the pulsation dampener 520 may be modified to allow the air side (also referred to as the “gas side,” which also may be nitrogen) of the internal diaphragm to be oscillated at the modulation frequency 540. In one embodiment, the pulsation dampener 520 may include a diaphragm or bladder that separates a fluid side from the gas side. The fluid side may include the process fluid that is pumped from the large high-pressure pump to the injection zone. The gas side may be coupled to a pressure modulation device, such as an actuator, modulator, piezoelectric driver, a secondary pump, or another device capable of oscillating the pressure of the gas side at a predetermined frequency or according to a programmable waveform. The oscillation of the pressure in the gas side of the pulsation dampener 520 may cause the diaphragm to move, thus imposing an oscillatory pressure signature upon the fluid side. It should be appreciated that the “gas side” of the pulsation dampener 520 may also be a liquid or a fluid. Therefore, there may be a liquid or fluid on one or both sides of the diaphragm of the pulsation dampener 520. In an embodiment, the gas side may be a non-compressible fluid. It should also be appreciated that the two “sides” of the internal diaphragm in the pulsation dampener 520 may generally be referred to as a “first side” and a “second side.”

The pump noise and high pressure 530 may be combined with the modulation frequency 540 to produce the modulation signature 550, which may be characterized by a frequency spectrum 560 and 570. The modulation signature 550 may be coupled to the fluid being transported to the injection zone, resulting in an alternating current streaming potential (AC-SP) at the injection zone 340 illustrated in FIG. 3. In some embodiments, the modulation frequency 540 may be dynamically adjusted in real time based on feedback from downhole or surface sensors to optimize signal detectability or to avoid interference from ambient noise sources.

Optionally, a further enhancement may be implemented using a small pump to oscillate the nitrogen or air charge pressure behind the diaphragm of a pulsation dampener 520 and enhance the sinusoid driven signal 540 on top of the high pressure from the pumps 530 in the fluid output manifold 510. The small pump may be a diaphragm pump, peristaltic pump, or any other suitable device capable of generating controlled pressure oscillations in the gas chamber of the pulsation dampener 520. In some embodiments, the modulation device may be electronically controlled and synchronized with the main pump operation to ensure precise phase and frequency alignment.

In implementation, an unmodified pulsation dampener, such as a CAT Pump 6018.800 Prrrrr-O-Lator Pulsation Dampener with Custom Charge—40 GPM (available from Kleen-Rite Corp. 257 South 9th Street PO Box 886 Columbia, PA 17512), may be used. Alternatively, a modified pulsation dampener may be used to defeat the dampening design to promote an enforced pressure/flow signature. Such modifications may include altering the internal geometry, changing the diaphragm material, or adjusting the pre-charge pressure to allow for greater amplitude of pressure oscillations. Additionally, a check valve 515 may be implemented on the high-pressure output manifold 510 downstream from any other pulsation dampeners in the system to prevent backflow and to isolate the modulated pressure signal. Alternatively, other pulsation dampeners in the system may either be disabled or modified, for example, to enable pressure fluctuations below 10 Hz.

In further embodiments, the system may include a controller configured to coordinate the operation of the main pump, the modulation device, and any auxiliary components such as valves or sensors. The controller may be programmed to generate complex modulation patterns, such as frequency sweeps or multi-frequency signals, to enhance the detectability of the AC-SP signal in various subsurface environments. The system may also include data logging and remote monitoring capabilities, allowing operators to adjust parameters and monitor system performance in real time.

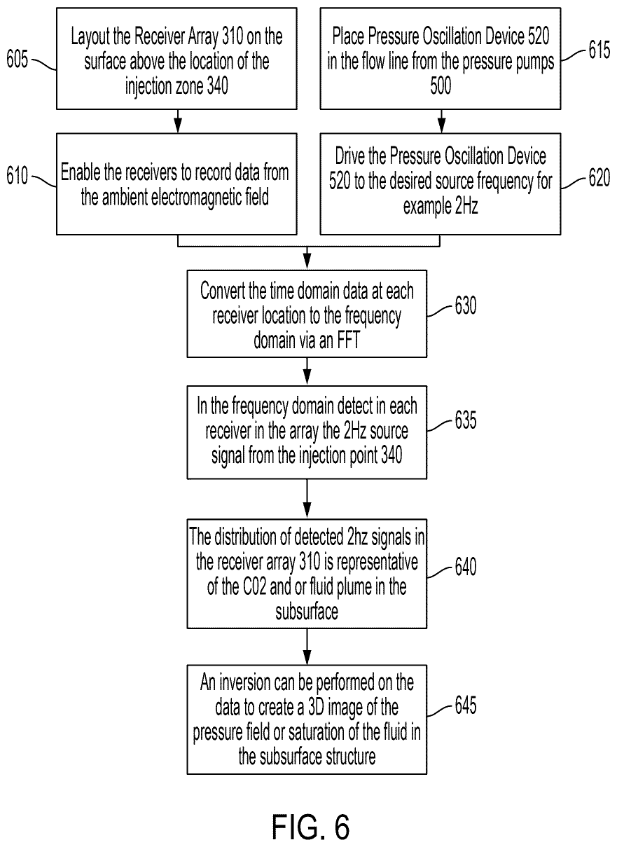

FIG. 6 is a flowchart showing an example of how a system may be set up to impose an oscillatory pressure signature on a high-pressure output of a large high-pressure pump in accordance with the disclosed embodiments. As shown in FIG. 6, operations may begin at 605, at which one or more receiver arrays are positioned on the surface above a location of an injection zone. The receiver arrays may comprise a plurality of electromagnetic field sensors, which may be arranged in a grid or other spatial configuration to optimize spatial resolution and signal-to-noise ratio.

Subsequently, at 610, the receivers are configured to record ambient electromagnetic field data. The configuration may include setting sampling rates, gain levels, and filtering parameters to optimize detection of the expected AC-SP signal frequencies. The receivers may be connected to a central data acquisition system via wired or wireless communication links, and may include GPS or other timing synchronization modules to ensure accurate time-stamping of recorded data.

Simultaneous to the operations performed at 605-610, or subsequently to them, a pressure oscillation device is positioned in the flow line from a pressure pump at 615. The pressure oscillation device may be any of the devices described above with respect to FIG. 5, and may be installed in-line with the fluid flow or in a bypass configuration. The device may be capable of generating pressure oscillations at a single frequency, multiple discrete frequencies, or according to a programmable waveform.

Thereafter, such a pressure oscillation device may be driven to a desired source frequency at 620, for example 2 Hz. The source frequency may be selected based on site-specific noise characteristics, subsurface properties, or regulatory requirements. In some embodiments, the system may perform a frequency sweep or use coded waveforms to improve subsurface imaging resolution or to discriminate between multiple injection zones.

As discussed above, in the frequency range of approximately 0.01 Hz-1 Hz, the power spectrum of the magnetic field decreases proportionally to f², with a magnitude from approximately 10⁻⁴ nT²/Hz down to approximately 10⁻⁷ nT²/Hz. In the range of approximately 1 Hz-50 Hz, the power spectrum slightly decreases at the level of approximately 10⁻⁷ nT²/Hz. Thus, it should be appreciated that the difference between these two frequency sub-ranges provides a technical advantage for signal detection. As a result, the improvement in background noise of ambient fields between the two frequency sub-ranges on SP signals provides technical utility and substantial benefit by being able to measure SP signal in the frequency domain (1 Hz-50 Hz), as compared to the conventionally available quasi-DC-SP measurement frequency ranges. Thus, using the AC-SP measurement, in accordance with the disclosed embodiments, significantly reduces the noise floor for the SP signal, making it possible to take advantage of the SP signal in a variety of potential applications, such as in CO₂ plume monitoring, hydraulic fracking, formation characterizations, hydrological testing, and geothermal assessment.

Returning to the detailed discussion of the example methodology shown in FIG. 6, following operations at 620, time domain electromagnetic field data recorded at each receiver location may be received in the receiver array. As discussed above with reference to FIG. 4A, a modulated pump flow rate and/or pressure may look like the curves 400, which is an example of a waveform combined with pump noise showing the modulation of the injection rate or pressure in accordance with disclosed embodiments. Various feasible waveforms for modulating the injection rate and/or pressure may be utilized including sine, square, sawtooth, triangle, Walch functions, chirps, and short chip count Pseudo Random numeric codes. These predetermined waveforms can be modulated on top of the required hydrostatic pressure to prevent affecting subsurface pressure requirements. In some embodiments, the modulation waveform may be adaptively selected based on real-time analysis of received signals to maximize signal-to-noise ratio or to target specific subsurface features.

Thereafter, control proceeds to 630, at which an FFT is applied to received time domain data to convert time domain data at each receiver location to frequency domain via the FFT. In implementation, the time domain data containing the pump noise and modulated waveform can be converted into frequency domain data in the plurality of surface receivers in the array or in a computer system that may collect the time domain data from the receiver array and convert it to the frequency domain. The FFT processing may be performed locally at each receiver, centrally at a field data acquisition unit, or remotely via cloud-based processing systems. In some embodiments, additional signal processing techniques such as bandpass filtering, noise cancellation, or matched filtering may be applied to further enhance the detectability of the AC-SP signal.

Subsequently, frequency domain data may be monitored in each receiver in the receiver array to detect for signals from the injection point at the desired source frequency at 635. The system may employ automated detection algorithms, such as thresholding, template matching, or machine learning classifiers, to identify the presence of the modulated signal. Operations proceed to 640 at which the distribution of detected signals at the desired source frequency is correlated in the receiver array to be representative of, for example, in various applications, the CO₂ and/or fluid plume in the subsurface.

Subsequently, a 3D image of the pressure field or saturation of the fluid in the subsurface structure may be created by performing an inversion function on the correlated data at 645. Such operations may be useful for monitoring how water and/or a CO₂ front is moving with time. The inversion process may utilize known subsurface models, regularization techniques, or iterative optimization algorithms to produce images of fluid distribution or movement.

Optionally, synchronization between pump modulation and the array of receivers may be performed to further reduce noise prior to using the FFT to convert the time-domain AC-SP data to the frequency-domain at 630. Synchronization may be achieved using GPS timing signals, wired synchronization pulses, or wireless communication protocols.

In this regard, it should be understood that the operations illustrated in FIG. 6 may be controlled, facilitated, or otherwise managed by a controller or controller software that is implemented or resident in whole or in part in various illustrated hardware and/or present in a computing device and/or servers that are accessible via a communication network such as the Internet or intranets. The controller may provide a user interface for configuring system parameters, visualizing real-time data, and generating reports. In some embodiments, the system may be integrated with other subsurface monitoring technologies, such as seismic, resistivity, or microseismic arrays, to provide a comprehensive assessment of subsurface conditions.

The various implementation approaches that may be used to modulate pump flow rate and/or pressure in accordance with the disclosed embodiments, are instructive. For example, in the presently disclosed AC-SP methodology, the system may measure the SP signal in the frequency domain by modulating the injection pump rate and/or pressure in an injection well. Compared with conventionally known passive SP (quasi-DC-SP) and active spCSEM methods, disclosed embodiments provide equipment and methodologies that can dramatically lower the noise floor imposed on the quasi-DC-SP signal. The modulation of the pump injection rate and/or pressure enables the measurement of low frequency content not previously measurable.

The causes for SP generally have two terms: the injection rate (Q (t), and the pressure gradient P (t). However, it is known that, generally, the frequency content in Q (t) and pressure gradient P (t) is very low, with a frequency that is less than 0.01 Hz, close to DC. This relationship is consistent with conventionally known and widely accepted SP observations such as are discussed in Wurmstich, B., and Morgan, F. D., 1994, MODELING OF STREAMING POTENTIAL RESPONSES CAUSED BY OIL WELL PUMPING, Geophysics, 59, 46-56.

However, disclosed embodiments implement something different in that disclosed embodiments utilize a modulated SP or AC-SP source with a much higher frequency range (1 Hz to 50 Hz). Such a modulated AC-SP source cannot be created by commonly used pumping equipment. In accordance with various disclosed embodiments, the AC-SP source signal is designed such that it combines with the pressure signature produced by the injection pumps, so that the AC-SP frequency is incoherent with the pressure signature of the pumps. In this way, the pump pressure may be used as a carrier for the AC-SP signal to its source subsurface.

To achieve measurement of the required frequencies, the following methods can be used separately or in combination, as would be understood by one of ordinary skill in the art.

The technical utility of such an innovation may be significant in multiple contexts. Measuring a higher frequency AC-SP signal rather than a conventional, traditional quasi-DC-SP signal enables the disclosed embodiments to have a much lower noise level, at least two to three orders of magnitude lower. As a result, disclosed embodiments enable measurement of a much smaller SP signal than could be performed using quasi-DC-SP measurements. Accordingly, disclosed embodiments may be of particular use in the field of CCUS, e.g., monitoring CCUS injection and leakage and monitoring CCUS plume extent.

Further, disclosed embodiments may be of particular use in hydraulic fracking monitoring and geothermal monitoring. Likewise, disclosed embodiments may be of particular use in EOR by water or CO₂, wherein chemicals are injected into an oil reservoir to improve recovery processes under control operations that take into consideration sensor-based temperature data, seismic data, the use of tracers to track flow movement and production logging.

Disclosed embodiments may be of particular use in formation evaluation in Logging While Drilling (LWD), which requires measurement of properties of subsurface formation while a well is being drilled. As a result, equipment used the measurement of such properties is performed using tools integrated into the bottomhole of drill bit assembly.

Disclosed embodiments may be of particular use for aquifer well testing in hydrology to evaluate a well's capacity and yield by determining, for example, a maximum prescribed water pumping rate that a well can support and an associated decrease in water level. Likewise, disclosed embodiments may be of particular use for wastewater injection monitoring for ensuring the protection of underground sources of drinking water by tracking functional parameters of wastewater injection wells. In this regard, disclosed embodiments may be used to improve the sensitivity of monitoring that may be performed for monitoring wastewater wells for plume extent.

The disclosed embodiments have been described, for purposes of explanation, with reference to numerous specific details are set forth in order to provide a thorough understanding of the details of the disclosed embodiments. However, it will be apparent to one skilled in the art that various disclosed embodiments may be practiced without, or with limited features disclosed herein.

Disclosed embodiments may be implemented in physical equipment, software or both. It should be understood that, although some of the description has been written in terms that relate to software or firmware, the features and functionality of various disclosed embodiments can be implemented in software, firmware, or hardware as desired, including any combination of software, firmware, and hardware. References to daemons, drivers, engines, modules, or routines should not be considered as suggesting a limitation of the embodiment to any type of implementation. The actual specialized control hardware or software code used to implement these systems or methods is not limiting of the implementations. Thus, the operation and behavior of the systems and methods are described herein without reference to specific software code with the understanding that software and hardware can be used to implement the systems and methods based on the description herein.

As used herein, satisfying a threshold may, depending on the context, refer to a value being greater than the threshold, greater than or equal to the threshold, less than the threshold, less than or equal to the threshold, equal to the threshold, or the like, depending on the context.

Although particular combinations of features are recited in the claims and disclosed in the specification, these combinations are not intended to limit the disclosure of various implementations. Features may be combined in ways not specifically recited in the claims or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such.

While certain example embodiments have been described in detail and shown in the accompanying drawings, it is to be understood that such embodiments are merely illustrative of and not devised without departing from the basic scope thereof, which is determined by the claims that follow.

What is claimed is:

1. An assembly for generating a modulated pressure signature in a fluid being transported to an injection zone, the assembly comprising:
a pump configured to deliver the fluid to a fluid output manifold;
a pulsation dampener fluidly connected to the manifold, the pulsation dampener comprising a barrier separating a first side from a second side, the first side comprising the fluid, and the second side comprising at least one of a gas, a liquid, or a non-compressible fluid;
a pressure modulation device coupled to the second side and configured to oscillate pressure of the second side at a modulation frequency, such that the output from the pump and the modulation frequency are combined to produce a modulation signature in the fluid, the modulation signature being characterized by a frequency spectrum;
wherein the modulation signature is coupled to the fluid being transported to the injection zone, thereby generating an alternating current streaming potential (AC-SP) at the injection zone.

2. The assembly of claim 1, wherein the pressure modulation device is selected from a group consisting of an actuator, a modulator, a piezoelectric driver, and an auxiliary pump.

3. The assembly of claim 1, wherein the pressure modulation device is configured to oscillate the pressure according to a waveform.

4. The assembly of claim 3, wherein the waveform comprises at least one of sine, square, sawtooth triangle, Walch functions, chirps, or Pseudo Random numeric codes.

5. The assembly of claim 1, further comprising a controller configured to coordinate operation of the pump or the pressure modulation device.

6. The assembly of claim 5, wherein the controller is programmed to generate modulation patterns, comprising frequency sweeps or multi-frequency signals.

7. The assembly of claim 5, wherein the controller is configured to provide data logging and remote monitoring of system performance.

8. The assembly of claim 1, wherein the pressure modulation device comprises a diaphragm pump or a peristaltic pump.

9. The assembly of claim 1, further comprising:
a check valve disposed on the fluid output manifold downstream of the pulsation dampener.

10. The assembly of claim 1, wherein the assembly is configured such that other pulsation dampeners in the assembly are disabled or modified to enable pressure fluctuations below 10 Hz.

11. The assembly of claim 1, wherein the second side of the pulsation dampener comprises nitrogen or air.

12. A method for detecting and imaging subsurface fluid distribution in an injection zone, comprising:
positioning an electromagnetic field receiver array comprising a plurality of receivers at a plurality of locations on a surface above the injection zone;
configuring the electromagnetic field receiver array to record electromagnetic field data;
operating a pressure oscillation device to generate pressure oscillations at a selected source frequency;
receiving time domain electromagnetic field data at each receiver of the plurality of receivers during operation of the pressure oscillation device;
processing the time domain electromagnetic field data to obtain frequency domain data using a Fast Fourier Transform;
identifying source signals at the selected source frequency in the frequency domain data at each receiver of the plurality of receivers;
correlating the identified source signals across the electromagnetic field receiver array to generate correlated data representative of subsurface fluid or pressure distribution; and
generating a three-dimensional image of the pressure field or fluid saturation in the subsurface structure by performing an inversion on the correlated data.

13. The method of claim 12, wherein the electromagnetic field receiver array is arranged in a spatial configuration to optimize spatial resolution and signal-to-noise ratio.

14. The method of claim 12, further comprising:
connecting the electromagnetic field receiver array to a central data acquisition system via wired or wireless communication links.

15. The method of claim 12, further comprising:
synchronizing the electromagnetic field receiver array using GPS timing signals, wired synchronization pulses, or wireless communication protocols to ensure accurate time-stamping of time domain electromagnetic field data.

16. The method of claim 12, wherein the pressure oscillation device is configured to generate pressure oscillations at a plurality of discrete frequencies or according to a programmable waveform.

17. The method of claim 12, wherein the pressure modulation device is selected from the group consisting of an actuator, a modulator, a piezoelectric driver, and an auxiliary pump.

18. The method of claim 12, further comprising:
controlling the pressure modulation device with a controller.

19. The method of claim 12, wherein the pressure modulation device is selected from the group consisting of a diaphragm pump and a peristaltic pump.

20. The method of claim 12, wherein the selected source frequency is 2 Hz.
